(19) United States
(12) Patent Application Publication
(10) Pub. No.: US 2025/0076862 A1
(43) Pub. Date: Mar. 6, 2025

(54) EDGE DEVICE SUPPORT OF COMPUTATION OF CONTEXTUALIZED HEALTH STATISTICS IN AN INDUSTRIAL AUTOMATION ENVIRONMENT

(71) Applicant: Rockwell Automation Technologies, Inc., Mayfield Heights, OH (US)

(72) Inventors: David C. Mazur, Mequon, WI (US); Marius G. Chis, Cambridge (CA); Ryan Coon, Franklin, WI (US); Scott D. Day, Richfield, WI (US); Lukasz Gornikowski, Kraków (PL); Roberto S. Marques, Mequon, WI (US); Jonathan A. Mills, Mayfield Heights, OH (US); Nathaniel S. Sandler, Cleveland, OH (US); Kurt D. Sneen, Park City, UT (US); Patryk Woszczyna, Krakow (PL)

(73) Assignee: Rockwell Automation Technologies, Inc., Mayfield Heights, OH (US)

(21) Appl. No.: 18/460,295

(22) Filed: Sep. 1, 2023

(51) Int. Cl. G05B 23/02

(52) U.S. Cl. CPC G05B 23/0216

(57) ABSTRACT

The present technology relates to health metrics corresponding to industrial automation devices and a user experience for configuring calculation devices to produce the health metrics. Health metrics of a device can be produced by obtaining performance metrics of the device and contextualizing the performance metrics based on contextualization information. The health metrics can be categorized based on applying rule sets to the health metrics. Contextualization and application of rule sets can be selectively performed by one or more calculation devices, such as one or more servers, industrial devices, user devices, or the like based on configuration settings. The calculation devices can obtain the performance metrics, operations, and rule sets to produce the health metrics for instantiation on a user interface.

### RELATED APPLICATIONS

This application is related to co-pending U.S. Patent Application, Attorney Docket No. 2023P-104-US, titled “MOBILE APPLICATION AND USER-EXPERIENCE WITH CONTEXTUALIZED HEALTH STATISTICS FOR INDUSTRIAL AUTOMATION DEVICES,” filed concurrently, and U.S. Patent Application, Attorney Docket No. 2023P-106-US, titled “HUMAN INTERFACE MODULE (HIM) CONNECTIVITY AND INTERFACE FOR CONTEXTUALIZED HEALTH STATISTICS IN AN INDUSTRIAL AUTOMATION ENVIRONMENT,” filed concurrently the contents of which are incorporated by reference in their entireties for all purposes.

### TECHNICAL FIELD

Various embodiments of the present technology relate to industrial automation devices and particularly to health statistics associated with industrial automation devices.

### BACKGROUND

Industrial automation environments, such as factories, mills, and the like, employ various devices like sensors and actuators (e.g., drives), machinery, and other components to perform industrial processes. Controllers and processors can automate various industrial systems and associated processes. For example, a controller connected to an industrial system can direct devices to perform functions in an integrated manner that, together, produce results. It is important to ensure that each device in the industrial system is working properly otherwise the industrial system as a whole may be at risk of failure.

Various solutions exist today to monitor industrial system performance and device performance. For example, sensors can be used to track outputs of devices in an industrial system. By way of another example, controllers connected to an industrial system may obtain data output by devices in the industrial system. Such solutions can generate copious amounts of data to perform trend analyses and monitor systems, among other features. However, the data generated by these solutions is not always helpful to end-users. Often times, such data is confined to what the vendor of the solution defines or to limitations of the sensors of a system. It may be cumbersome or even impossible to re-define or re-program sensors or monitoring solutions. Furthermore, it may be difficult to balance where processing of such data occurs given the amount of data and the architecture of such solutions. Accordingly, some of the data gathered by sensors and systems may be obsolete by the time the data is requested by a user due to latency issues, for example. Thus, these solutions can fail to process and provide insights into the data based on end-user requirements at run-time of an industrial system.

### SUMMARY

Systems, devices, and methods are provided herein for producing health metrics associated with industrial devices by one or more calculation devices in an industrial automation environment and instantiating the health metrics on a user interface to visualize health information about the industrial devices. An industrial, commercial, or industrial automation environment may include various industrial automation devices, such as variable-speed drives, motors, belts, and the like, that perform industrial automation processes. More particularly, a variable-speed drive may be coupled to various other devices and control an industrial automation process via the other devices. A variable-speed drive may receive signals from connected devices indicative of performance of the devices (also referred to as performance metrics). Such performance metrics can be contextualized and used with rule sets by one or more calculation devices to analyze the health of the variable-speed drive and connected devices. The health information related to the devices can be provided to a user interface navigable by a user for the user to view performance, health, and conditions of the devices.

In an embodiment of the present technology, a method of selecting one or more calculation devices for producing device health information is provided. The method includes obtaining a request from a user device for device health information corresponding to a device in an industrial automation environment. The method also includes identifying, based on the request, performance metrics associated with the device and one or more operations for producing the device health information from the performance metrics. The method further includes identifying one or more calculation devices to perform at least a subset of the one or more operations, and providing the performance metrics, the subset of the one or more operations, and an instruction to perform the subset of the one or more operations on the performance metrics to the one or more calculation devices to produce the device health information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example operating environment in accordance with some embodiments of the present technology.

FIGS. 2A, 2B, and 2C illustrate example block diagrams of components capable of producing device health metrics in accordance with some embodiments of the present technology.

FIG. 3 illustrates an example series of steps for identifying and selecting calculation devices for producing device health information in accordance with some embodiments of the present technology.

FIGS. 4A, 4B, and 4C illustrate example representations of user interfaces including device health metrics of industrial automation devices in accordance with some embodiments of the present technology.

FIG. 5 illustrates an example computing system used in some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology relate to health metrics corresponding to devices in an industrial automation environment, and more particularly, to a user experience for configuring calculation devices to produce the health metrics based on a request for the health metrics. In industrial and commercial environments, various devices, such as drives, motors, relays, sensors, and the like along with the driven machinery, such as conveyors, pumps, fans, and more, which can be used to perform industrial, manufacturing, and commercial processes. Processes involving such devices may be automated through the use of processors and controllers coupled to the devices. However, data gathered from the devices during run-time operations of industrial processes is often unhelpful and limited. For example, controllers coupled to devices may have limited interfaces that only show a few metrics or signals coming from a connected device. The signals obtained from these controllers may only indicate performance data at a given time on such interfaces. In conventional solutions, vast amounts of data are often gathered and run through complex software to understand if the way in which the devices are being operated is appropriate or sustainable without issues. However, customization and contextualization of data based on end-user needs is not offered or requires re-programming from software engineers trained on the solutions. Further, the processing capacity required to gather and contextualize such data to produce insightful data is often constrained.

To address these issues, a system that can gather performance metrics from various industrial devices, analyze the health and condition of the devices, and predict unhealthy behavior based on the performance metrics is provided. Further, the system can balance the processing required to perform such activities among one or more calculation devices. The system can intake requests from users for customized and contextualized device health information associated with one or more industrial devices in an industrial automation environment. Importantly, the calculation devices can be configured to perform requested operations based on a defined balancing scheme, or on-the-fly, to distribute processing loads among the calculation devices to reduce latency, for example. Further, the calculation devices can provide indications of the health, condition, and performance to a user interface having navigable dashboards for a user to view information about the devices and take actionable measures to alleviate current risks or prevent future risks in the industrial environment. The outputs of the system can be generated based on end-user configurations and customizations through a user experience that also displays the outputs.

In an embodiment of the present technology, a method of selecting one or more calculation devices for producing device health information is provided. The method includes obtaining a request from a user device for device health information corresponding to a device in an industrial automation environment. The method also includes identifying, based on the request, performance metrics associated with the device and one or more operations for producing the device health information from the performance metrics. The method further includes identifying one or more calculation devices to perform at least a subset of the one or more operations, and providing the performance metrics, the subset of the one or more operations, and an instruction to perform the subset of the one or more operations on the performance metrics to the one or more calculation devices to produce the device health information.

In another embodiment, one or more computer-readable storage media having program instructions stored thereon is provided. The program instructions, when read and executed by one or more processors, direct the one or more processors to perform various functions. For example, the program instructions may direct the one or more processors to obtain a request from a user device for device health information corresponding to a device in an industrial automation environment and identify, based on the request, performance metrics associated with the device and one or more operations for producing the device health information from the performance metrics. The program instructions may further direct the one or more processors to identify one or more calculation devices to perform at least a subset of the one or more operations and provide the performance metrics, the one or more operations, and an instruction to perform the one or more operations on the performance metrics to the one or more calculation devices to produce the device health information.

Advantageously, a system that can distribute operations for producing device health information among one or more calculation devices and provide a user experience to configure balancing of the one or more calculation devices can provide a tool for users to produce device health information from raw data obtained from industrial devices and indications of the device health information related to performance, health, and condition of the industrial devices for viewing on a user interface. Not only may this equip a user with insightful metrics related to performance and health of an industrial device in a processing-efficient manner, but also this may reduce overhead for purchasing and operating complex software programs pre-configured to analyze specific measurements and risks associated with an industrial automation system. Accordingly, implementing load balancing among various calculation devices configurable by a user may reduce processing and memory requirements for certain computing systems because device health processes can be performed by various devices based on available processing capacities, the type of information requested, the devices associated with the information requested, and the like. Additionally, such a user experience can also allow a user to re-define or configure customized device health information and associated calculation devices as necessary without requiring the expertise of a software engineer. This can further impact processing and memory requirements as operations and logic for performing device health processes can be simplified and distributed to one or more processing systems available in an industrial automation environment, such as devices themselves, controllers of the devices, and one or more different servers as configured by the user.

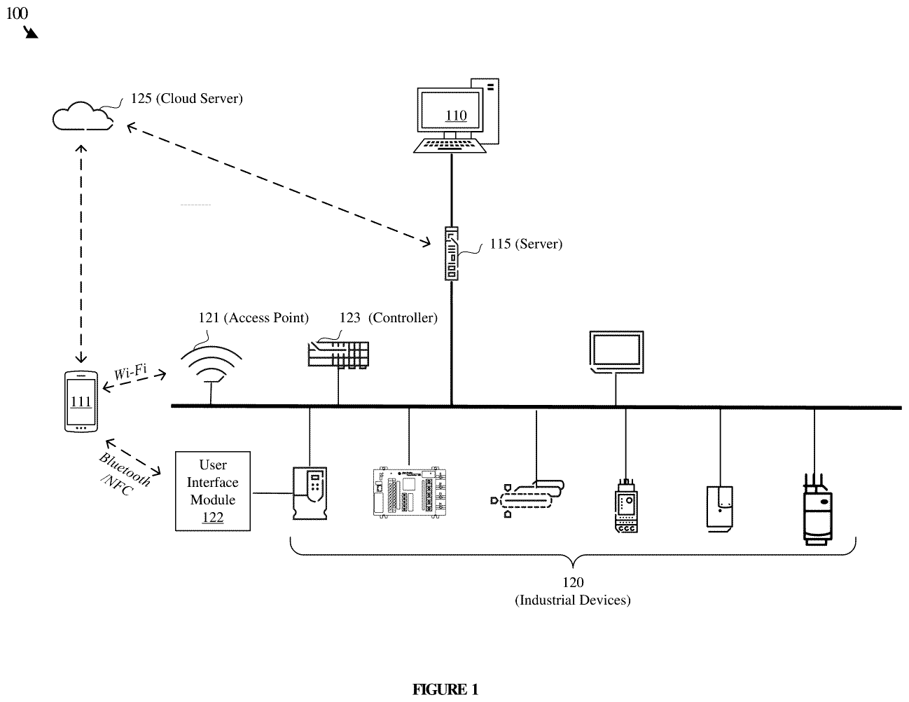

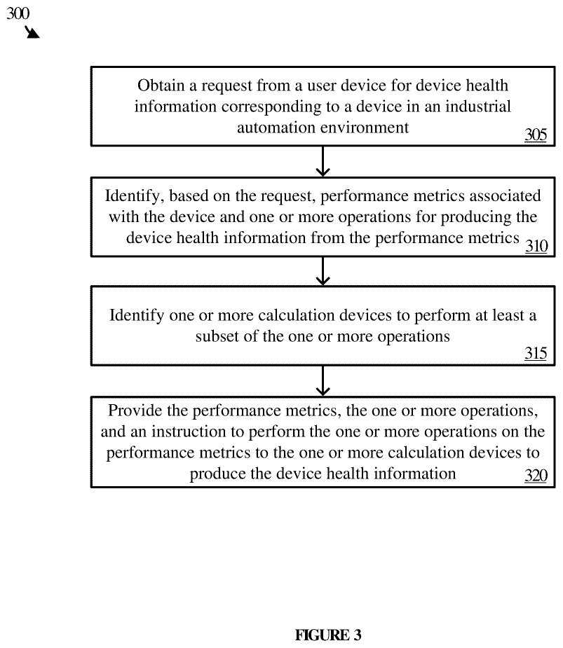

Turning now to the Figures, FIG. 1 illustrates an example operating environment 100 demonstrating industrial, commercial, and automation elements. Operating environment 100 includes user device 110, user device 111, server 115, industrial devices 120, access point 121, and cloud server 125. In various examples, server 115 may be configured to perform device health processes, such as process 300 of FIG. 3, and provide device health metrics to a user interface of a user device, such as user devices 110 and 111.

Operating environment 100 is representative of an environment in which industrial and commercial processes can occur, and in which a user may operate a user device (e.g., user device 110, user device 111) to view device health information (i.e., metrics, statistics, parameters, and characteristics related to health, performance, and condition) of industrial devices 120 used in performing industrial and commercial processes.

User device 110 is an example of a computing device operable in operating environment 100. User device 110 may include a screen and one or more peripheral devices to operate user device 110. User device 110 can display an instance of a device health application on the screen, which may include one or more dashboards having status indicators, behavior indicators, preventative or predictive maintenance indicators, and the like, related to industrial devices 120. User device 110 may download and run the device health application, or user device 110 may surface the device health application via a web-based browser. The one or more peripherals, such as a mouse, for example, can be used to navigate and interact with the device health application on a user interface displayed on the screen of user device 110. For example, a user can navigate the device health application to view various device health metrics related to industrial devices 120. Furthermore, the user can use the device health application to configure device health metrics to customize the device health metrics as needed based on the operation of industrial devices 120.

Server 115 is an example of one or more servers, processors, or other computing devices operating in operating environment 100. In some examples, server 115 may be an edge server located on the premises of an industrial automation environment. In other examples, server 115 may be located remotely from the industrial automation environment (i.e., a cloud-based server). Server 115 may include hardware, software, and firmware, or any combination or variation thereof, to perform device health processes. Server 115 may obtain data from industrial devices 120, controller 123, or one or more of human interface module 122 coupled to industrial devices 120 via a wired connection at an industrial facility or via a wireless connection such as by using a communication network. Server 115 may further communicate with cloud server 125 via a secure, wired or wireless communication network.

Industrial devices 120 include various types of industrial and commercial devices that may be used to perform respective processes in operating environment 100. For example, industrial devices 120 may include one or more of variable-speed drives, motors circuit devices, relays, sensors, and more. Various components of industrial devices 120 may be coupled together via wired or wireless connections, such as through access point 121. As industrial devices 120 perform respective processes, industrial devices 120 can produce signals and measurements indicative of performance. A variable-speed drive may produce various signals from a motor connected to it. By way of example, the variable-speed drive may provide signals indicative of a motor voltage, a motor temperature, or a motor speed, among other signals. Such signals can be obtained by server 115 or user device 111.

In other examples, controller 123, coupled to one or more of industrial devices 120, may obtain the signals and measurements indicative of performance of industrial devices 120 and provide the signals and measurements to other components. Controller 123 is representative of a controller or control module, such as a PLC or an analytic option card, associated with a device in operating environment 100. In some examples, controller 123 may be externally coupled with one or more of industrial devices 120 and can control functionality of the devices. In other examples, controller 123 may be installed in one or more of industrial devices and can provide device health analytics control and monitoring.

User interface module 122 may be representative of a user interface device that can be coupled to one or more of industrial devices 120 to display information about the performance and health of industrial devices 120. User interface module 122 may be associated with a single device. User interface module 122 may, however, be associated with multiple devices. Regardless, controller 123 and/or user interface module 122 may control operations of respective industrial devices 120 and provide data to server 115 or user device 111 based on the performance of the respective industrial devices 120.

Access point 121 is representative of a wireless network connection point for connecting one or more devices to a communication network in the industrial automation environment. In various examples, one or more of industrial devices 120 may be connected to access point 121. Server 115 may also be connected to the same communication network that access point 121 provides access to. Thus, server 115 may obtain data associated with industrial devices 120 via a communication network accessible through access point 121.

Access point 121 can also provide a wireless connection point for user device 111 to connect to the communication network and to obtain data from industrial devices 120 or server 115. User device 111 is representative of a handheld mobile device, such as a smart phone or tablet, which can connect to devices in operating environment 100 via wireless connections. For example, user device 111 can connect to access point 121 via a Wi-Fi connection. User device 111 may, alternatively or additionally, connect to industrial devices 120 via user interface module 122 of industrial devices 120. In various examples, user device 111 can connect to user interface module 122 or any of the industrial devices 120 via a Bluetooth connection or via a near field communication (NFC) protocol. In such examples, user device 111 may be located in close proximity to user interface module 122, industrial devices 120, and access point 121 to interface with such components.

User device 111 may also be connected to cloud server 125 via the same communication network provided by access point 121 or a different communication network. Cloud server 125 is representative of a cloud-based environment in which at least some other operations for device health processes may be performed. In various examples, cloud server 125 may include one or more servers, processors, databases, datacenters, and the like capable of receiving performance metrics and device health metrics from server 115 or user device 111. Cloud server 125 may obtain data from server 115 and user device 111, perform device health processes on the data, and provide device health metrics, or indications of the device health metrics, to server 115 and user device 111 for instantiation on a user interface of user devices 110 and 111.

Like user device 110, user device 111 may also include a user interface for displaying an instance of a device health application. User device 111 may download the device health application from an application store or access the instance of the device health application from a browser. The instance displayed on user device 111 may include one or more navigable dashboards having status indicators, behavior indicators, preventative or predictive maintenance indicators, and the like, related to industrial devices 120. Similarly, a user of user device 111 can navigate the device health application displayed on user device 111 to view, configure, and customize device health metrics associated with industrial devices 120. In some examples, the instance of the device health application operable on user device 111 may differ from the instance of the device health application operable on user device 110. For example, dashboards available for navigation on user device 110 may differ in size and information relative to dashboards available for navigation on user device 111. Regardless, the indications and information displayed on user device 110 may be obtained from server 115, cloud server 125, controller 123, user interface module 122 of industrial devices 120, or industrial devices 120 via a communication network.

In operation, a user may request device health metrics associated with one or more industrial devices 120 via user device 110 or user device 111. From user device 110, the request can be provided to server 115. Server 115 can identify the request and the respective industrial device based on the request. Server 115 can obtain performance metrics from the industrial device, from controller 123 associated with the industrial device, or from user interface module 122 associated with the industrial device. Then, server 115 can perform operations on the performance metrics to contextualize the performance metrics based on contextualization information specific to the performance metrics and produce device health metrics. Contextualization information may include information indicative of a type of value (e.g., voltage, temperature, current) of the performance metrics. By way of example, for a request seeking information about health of a motor in the industrial automation environment, a performance metric related to motor speed may be obtained. Contextualization of the motor speed may include identifying the type of performance metric and the unit of measurement of the performance metric (e.g., rotations per minute (RPM)) and converting the value of the performance metric to a percentage. Thus, the contextualized performance metric, or device health metric, may indicate at what percentage of capable motor speed the motor is running (e.g., 85%).

Server 115 may also apply one or more rule sets to the device health metrics to produce device health metrics categories, including a healthy category, an unhealthy category, and an approaching unhealthy category, among other categories. The rule sets may include threshold values, time windows or time ranges, or other defined rules. Following the previous example using percentage of motor speed, the request may seck information corresponding to the health of the device when operating with such performance. A first rule set can be applied to determine the duration that the motor has been running at the motor speed. A second rule set can further be applied to determine whether the motor has been running beyond a threshold value for a threshold duration. As a result of applying the rule sets, server 115 can determine whether the motor is operating in a healthy state, an unhealthy state, or an approaching unhealthy state. Server 115 can provide both the device health metrics and the device health metrics categories to user device 110 for instantiation on the user interface of user device 110.

From user device 111, the request for device health metrics can be provided to cloud server 125, server 115 (via access point 121), or industrial devices 120 (either directly or via controller 123 or user interface module 122). Cloud server 125 and industrial devices 120 may provide the request to server 115 to perform operations on the performance metrics as described above. However, in some cases, cloud server 125 or industrial devices 120 may perform at least a subset of the operations on the performance metrics instead of or in addition to providing the request to server 115 to perform operations on the performance metrics. In either case, the contextualization and rule sets may be performed on the performance metrics to produce device health metrics and device health metrics categories, respectively, based on the request. Server 115 or cloud server 125 can then provide the device health metrics and device health metric categories to the user interface of user device 111.

In various examples, cloud server 125 and server 115 may store performance metrics gathered from industrial devices 120 based on requests in one or more databases. Thus, previously stored performance metrics can be used to provide historical health metrics, trend analysis, predictive maintenance metrics, and the like to user devices 110 or 111 based on requests.

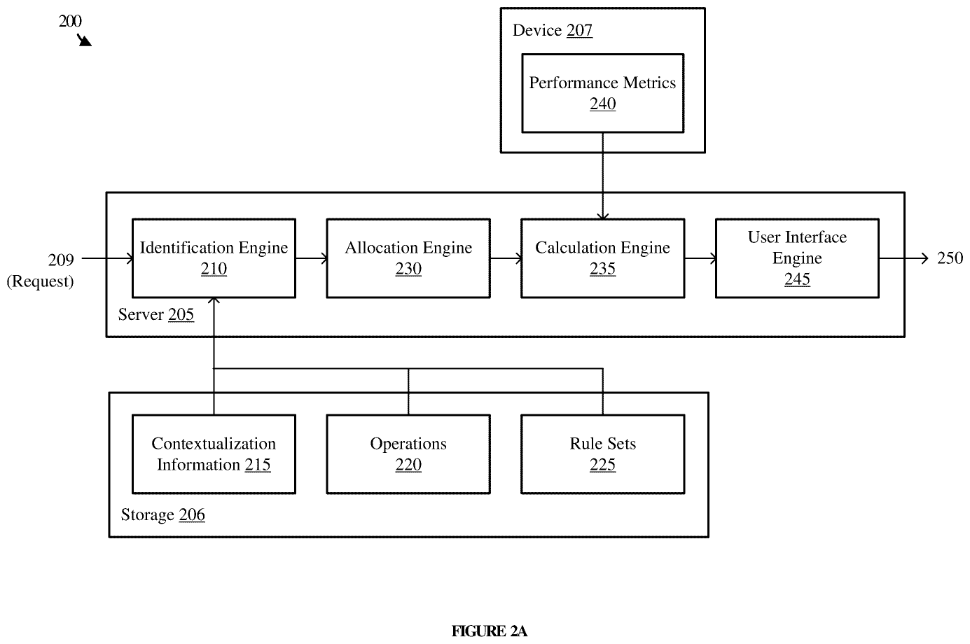

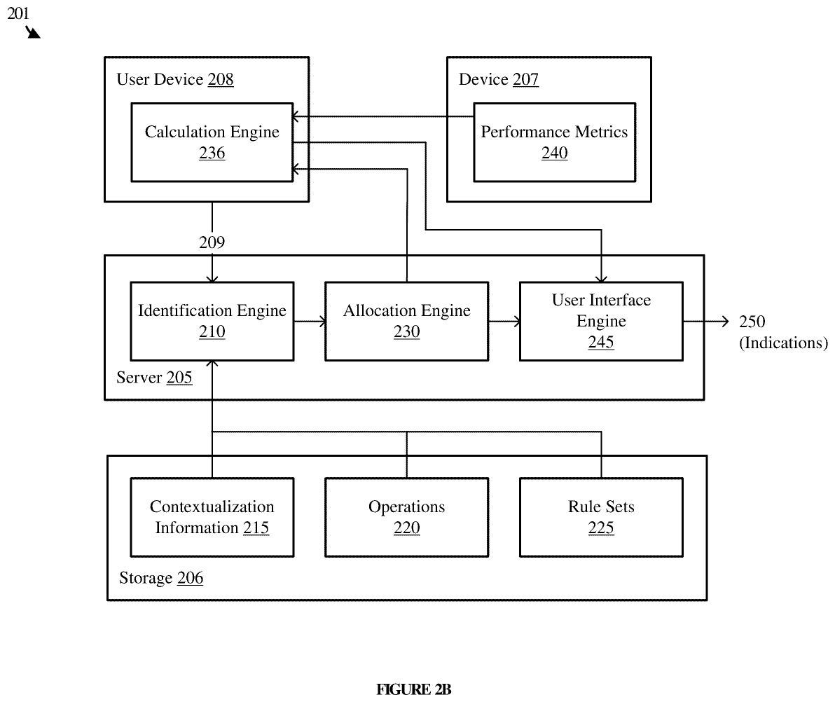

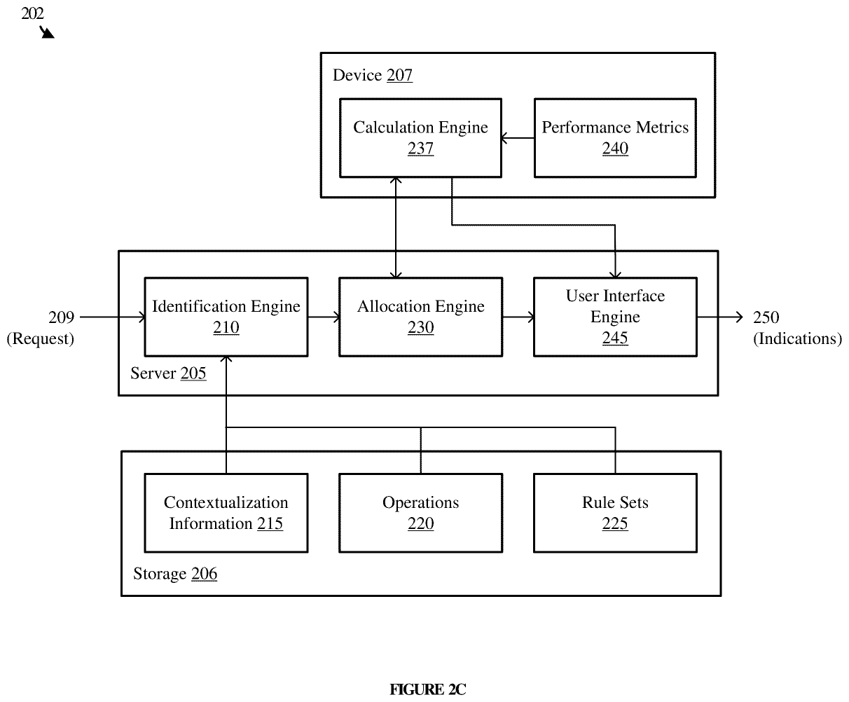

FIGS. 2A, 2B, and 2C illustrate example block diagrams of components capable of producing device health metrics in accordance with some embodiments of the present technology. FIG. 2A includes block diagram 200, FIG. 2B includes block diagram 201, and FIG. 2C includes block diagram 202, each of which includes a combination of server 205, storage 206, device 207, and user device 208.

Referring first to FIG. 2A, FIG. 2A shows block diagram 200, which includes server 205, storage 206, and device 207. The components of block diagram 200 may be representative of respective components of operating environment 100 of FIG. 1. For example, server 205 may represent server 115, and device 207 may represent one or more of industrial devices 120.

Server 205 is representative of one or more servers, processors, or other computing devices capable of performing device health processes and producing indications 250 for visualization on a user interface of a user device. In some examples, server 205 may be an edge server that is located on the premises of an industrial automation environment. Alternatively, server 205 may be located remotely from an industrial automation environment. Server 205 may include hardware, software, and firmware components, or any combination or variation thereof, to perform such operations. Examples of such components may include identification engine 210, allocation engine 230, calculation engine 235, and user interface engine 245. Identification engine 210, allocation engine 230, calculation engine 235, and user interface engine 245 may function independently from one another, however, they may also function in an integrated manner.

Request 209 is provided to server 205 from a user device (not shown) (e.g., user device 208 of block diagram 201). Request 209 includes a request for device health information related to one or more devices of the industrial automation environment, such as device 207. For example, request 209 may seek metrics indicative of performance and health of one or more devices, such as performance metrics 240 of device 207. Performance metrics 240 may include signals and measurements indicative of performance of respective industrial devices. For example, performance metrics 240 may include voltage measurements, motor speed, device temperature, and the like of one or more industrial devices.

More specifically, identification engine 210 of server 205 may receive request 209. Identification engine 210 is representative of one or more processors capable of receiving request 209 and identifying the desired device health information and corresponding devices of request 209. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof. Identification engine 210 can obtain contextualization information 215, operations 220, and rule sets 225 based on request 209 from storage 206.

Storage 206 is representative of one or more databases capable of being read from and written to by server 205 and associated components. Storage 206 may include volatile and nonvolatile, removable and non-removable media elements implemented in any method of technology for storage of information, such as contextualization information 215, operations 220, and rule sets 225. Storage 206 is shown as a single component external to server 205 but may be implemented as one or more storage devices and may include devices for storing software and firmware. As such, storage 206 may be implemented separately or in an integrated manner with respect to other types of storage. Storage 206 is not a transitory signal in any embodiment. Storage 206 may also be internal to server 205.

Contextualization information 215 includes information for the contextualization of performance metrics 240 specific to a type of performance metric (e.g., an output value, a predictive maintenance value, a preventative maintenance value). For example, contextualization information 215 may include information indicative of a type of a value (e.g., voltage, temperature, current, speed) or unit of measurement of a value (e.g., volts, degrees Fahrenheit, amps, RPM). By way of example, performance metrics 240 may be related to motor speed. Contextualization information 215 may include information indicating that performance metrics 240 includes a speed and a unit of measurement of the speed.

Operations 220 includes one or more operations that may be used to contextualize performance metrics 240. Contextualization of performance metrics 240 refers to providing context to performance metrics 240 to make performance metrics 240 more useful and insightful to a user reading performance metrics 240. In various examples, operations 220 may include mathematical operations, filter functions, compare functions, and the like. In one example, a re-formatting operation can be performed on performance metrics 240 to change performance metrics 240 from one type of data to a different type of data. In another example, a conversion operation may be performed on performance metrics 240 to convert an output from one unit of measurement to another unit of measurement. In yet another example, a maximum value operation may be performed to capture the maximum value of a signal, such as motor peak current, during a period of time.

Rule sets 225 may include threshold values, time windows or time ranges, or other defined rules specific to contextualized performance metrics. In some cases, rule sets 225 may be user-defined and may include pre-configured rules, threshold values, or a combination based on device 207 and associated performance metrics 240, among other factors. In an example, request 209 may seek information corresponding to the health of device 207 when operating at a percentage of total capable motor speed. A first rule set can be applied to determine the duration that the motor has been running at the motor speed. A second rule set can also be applied to determine whether the motor has been running beyond a threshold value for a threshold duration. As a result of applying rule sets 225, it can be determined whether the motor is operating in a healthy state, an unhealthy state, or an approaching unhealthy state.

In various examples, identification engine 210 may identify subsets of contextualization information 215, operations 220, and rule sets 225 to use for producing device health information based on request 209 and configuration settings defined by a user in a device health application running on a user device (e.g., user device 110 or 111 of FIG. 1, user device 208). For example, a user can define operations 220 and rule sets 225 and select which operations 220 and rule sets 225 can be applied to performance metrics 240. For example, a user can define rule sets 225 to include threshold values, time ranges, and other values and rules, and associate the defined settings with one or more devices or performance metrics associated with the devices. In other examples, default configuration settings may include one or more rule sets that can be used based on a type of device health metric. Further, the user can define the contextualization information 215 and select which contextualization information 215 is associated with performance metrics 240. Various other ways of configuring the operations and contextualization metrics may be contemplated.

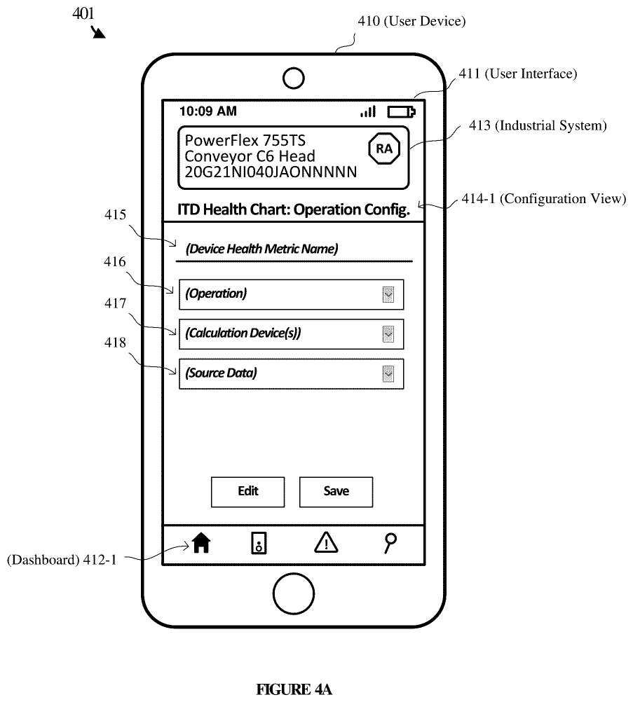

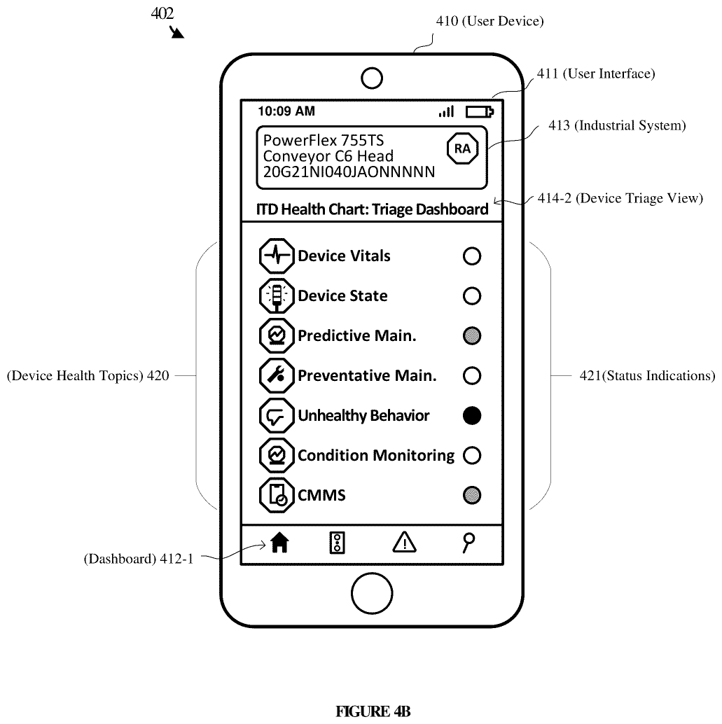

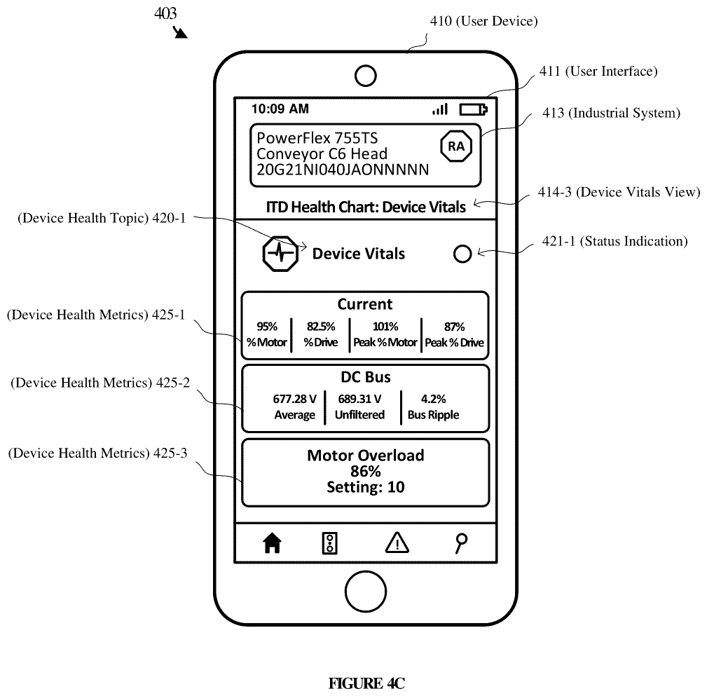

Allocation engine 230 can receive contextualization information 215, operations 220, and rule sets 225 from identification engine 210 along with the desired device health information and corresponding device. Allocation engine 230 is also representative of one or more processors or other computing devices of server 205. Allocation engine 230 can determine where operations 220 and rule sets 225 can be performed and applied, respectively. Allocation engine 230 may provide contextualization information 215, operations 220, and rule sets 225 to a device of the industrial automation environment (e.g., device 207), a controller coupled to the device (not shown), a user device (not shown), or another processor of server 205 (e.g., calculation engine 235) (also referred to as calculation devices or engines) based on one or more factors. For example, allocation engine 230 may identify to which location to provide such information based on available processing capacities of the locations, a type of respective operations 220, a type of respective rule sets 225, the device or controller, or a pre-determined processing location, among other factors. For example, a user can associate contextualization information 215, operations 220, and rule sets 225 with one or more calculation devices during a configuration process. An example of a configuration view is illustrated and described with respect to FIG. 4A. In some examples, allocation engine 230 may instead provide a subset of such information to one of the aforementioned locations and another subset of such information to a different location. Any variation or combination of processing locations may be contemplated. In this example, allocation engine 230 can determine that calculation engine 235 of server 205 can perform operations 220 and rule sets 225.

Calculation engine 235 is an example of one or more processors or other computing devices capable of producing the device health information requested in request 209 by performing operations 220 and applying rule sets 225 to performance metrics 240. In addition to receiving contextualization information 215, operations 220, and rule sets 225, calculation engine 235 can also receive performance metrics 240 from device 207. Calculation engine 235 can use contextualization information 215 and operations 220 to contextualize performance metrics 240 and produce device health metrics associated with device 207. Calculation engine 235 can further apply rule sets 225 to the device health metrics to produce device health metrics categories. The device health metrics categories may include a healthy category, an unhealthy category, and an approaching unhealthy category, among other categories. Calculation engine 235 can provide the device health metrics and device health metrics categories to user interface engine 245.

User interface engine 245 is also representative of one or more processors or computing devices capable of surfacing indications 250 to a user interface of a user device or a controller coupled to device 207 (not shown). User interface engine 245 can obtain device health metrics and device health metrics categories from calculation engine 235 and produce indications 250 from the device health metrics and device health metrics categories.

Indications 250 include representations of the data of the device health metrics and device health metrics categories for display on a user interface of a user device. For example, indications 250 may include color indicators, such as green, yellow, and red, based on device health metrics categories, such as healthy, approaching unhealthy, and unhealthy, respectively. Indications 250 may also include values, units of measurement, and names corresponding to the device health metrics and device health metrics categories for display on the user interface. User interface engine 245 can provide indications 250 to a user device (e.g., a computing device, a smart phone, a tablet), such as user devices 110 or 111 of FIG. 1.

Referring next to FIG. 2B, FIG. 2B shows block diagram 201, which includes server 205, storage 206, device 207, and user device 208. As illustrated in block diagram 201, user device 208 can include calculation engine 236 to produce device health metrics and device health metrics categories instead of calculation engine 235 of server in block diagram 200.

User device 208 is representative of a computing device operable by a user to configure, request, and otherwise interact with server 205 and device 207 in an industrial automation environment. For example, user device 208 may be a computer including a screen and one or more peripheral devices. In another example, user device 208 may be a mobile device, such as a smart phone or tablet. Regardless, user device 208 can display an instance of a device health application on a screen, the device health application including one or more dashboards having status indicators, behavior indicators, preventative or predictive maintenance indicators, and the like, related to devices in the industrial automation environment (e.g., device 207). A user can navigate the device health application to view various device health metrics and device health metrics categories related to the devices. Furthermore, the user can use the device health application to configure device health metrics to customize the device health metrics as needed.

User device 208 may provide request 209 for device health information to server 205. After identification engine 210 receives request 209 and obtains contextualization information 215, operations 220, and rule sets 225, identification engine 210 can provide such information to allocation engine 230. In this example, allocation engine 230 can determine that user device 208 can perform operations 220 and apply rule sets 225 to performance metrics 240. Accordingly, allocation engine 230 provides contextualization information 215, operations 220, and rule sets 225 to calculation engine 236 of user device 208.

Calculation engine 236 is an example of one or more processors or other computing devices of user device 208 capable of producing the device health information requested in request 209 by performing operations 220 and applying rule sets 225 to performance metrics 240. In addition to receiving contextualization information 215, operations 220, and rule sets 225, calculation engine 236 can also receive performance metrics 240 from device 207. Calculation engine 236 can use contextualization information 215 and operations 220 to contextualize performance metrics 240 and produce device health metrics associated with device 207. Calculation engine 236 can further apply rule sets 225 to the device health metrics to produce device health metrics categories. The device health metrics categories may include a healthy category, an unhealthy category, and an approaching unhealthy category, among other categories. Calculation engine 236 can provide the device health metrics and device health metrics categories to user interface engine 245 for instantiation of indications 250 on a user interface of user device 208, among other user devices (not shown).

FIG. 2C shows block diagram 202, which includes server 205, storage 206, and device 207. As illustrated in block diagram 202, device 207 can include calculation engine 237 to produce device health metrics and device health metrics categories instead of calculation engines 235 or 236 as in block diagrams 200 and 201, respectively.

Calculation engine 237 is an example of one or more processors or other computing devices of device 207 capable of producing the device health information requested in request 209 by performing operations 220 and applying rule sets 225 to performance metrics 240. Calculation engine 237 can receive contextualization information 215, operations 220, and rule sets 225 from allocation engine 230. Calculation engine 237 can also obtain performance metrics 240 from device 207. Calculation engine 237 can use contextualization information 215 and operations 220 to contextualize performance metrics 240 and produce device health metrics associated with device 207. Calculation engine 237 can further apply rule sets 225 to the device health metrics to produce device health metrics categories. The device health metrics categories may include a healthy category, an unhealthy category, and an approaching unhealthy category, among other categories. Calculation engine 237 can provide the device health metrics and device health metrics categories to user interface engine 245 for instantiation of indications 250 on a user interface of user device 208, among other user devices (not shown).

While block diagrams 200, 201, and 202 illustrate examples of using a single calculation device to produce device health metrics and device health metrics categories, any number, combination, or variation of calculation devices 235, 236, and 237 may be used in device health processes. For example, a first subset of contextualization information 215, operations 220, rule sets 225, and performance metrics 240 may be provided to a first calculation device, and a second subset may be provided to a second calculation device. In such examples, each calculation device can provide device health metrics and categories to server 205 for instantiation on one or more user interfaces based on request 209.

FIG. 3 illustrates a series of steps for identifying and selecting calculation devices for producing device health information in accordance with some embodiments of the present technology. FIG. 3 includes process 300, each operation noted parenthetically in the discussion below and which reference elements of FIG. 1. It may be appreciated that process 300 can be implemented on software, firmware, hardware, or any combination or variation thereof. For example, process 300 can be executed on or by a server in an industrial automation environment, such as server 115 or cloud server 125 of FIG. 1, or server 205 of FIG. 2A, 2B, or 2C.

In operation 305, server 115 obtains (305) a request from user device 110 or 111 for device health information corresponding to a device of industrial devices 120 in an industrial automation environment. In other examples, however, cloud server 125 may also, or instead, obtain the request and perform additional steps following this step. The request may include a request for metrics and statuses indicative of performance and health of the device. More specifically, the request may include a type of metric, an output unit of measurement of the metric, and the device, among other information. User device 110 or 111 may provide the request to server 115 via a communication network. In various examples, user device 110 or 111 provides the request from a device health application that can display indications of the device health information on a user interface of user device 110 or 111.

In operation 310, server 115 identifies (310) performance metrics associated with the device and one or more operations for producing the device health information from the performance metrics based on the request from user device 110 or 111. Performance metrics associated with the device may include signals and measurements indicative of performance of the device. For example, the performance metrics may include temperatures, output voltages, output currents, motor speeds, torque, and the like, each associated with one or more industrial devices 120. It follows that the performance metrics may indicate a performance of industrial devices 120, such as “off,” “on,” and varying levels of performance while “on.” In some examples, server 115 may obtain the performance metrics directly from the device. In other examples, server 115 may obtain the performance metrics from one or more controllers associated with the device (e.g., controller 123) or from one or more user interface modules (e.g., user interface module 122). Regardless, server 115 may obtain the performance metrics during run-time or following use of industrial devices 120 in an industrial process.

Next, in operation 315, server 115 identifies (315) one or more calculation devices to perform at least a subset of the one or more operations for producing the device health information from the identified performance metrics. Examples of calculation devices may include user device 110, user device 111, one or more of industrial devices 120, such as the device identified in the request, a controller coupled to one or more of industrial devices 120 (e.g., controller 123), a human interface module (HIM) or user interface module (e.g., user interface module 122), server 115, and cloud server 125. The calculation devices may be capable of producing device health information by contextualizing the performance metrics, performing operations on the performance metrics, and applying rule sets to the contextualized performance metrics.

In various examples, server 115 may select one or more calculation devices based on available processing capacities of the calculation devices, types of the operations requested to be performed, types of rule sets requested to be applied, the device or controller associated with the request, or a pre-determined processing location, among other factors. With respect to the pre-determined processing location, a user may associate contextualization information, operations, and rule sets with one or more calculation devices during a configuration process. Thus, based on the request for specific performance metrics, server 115 can determine a corresponding calculation device based on the specific performance metrics. In some examples, a single calculation device can be used to produce device health information. However, in other examples, any number, combination, or variation of calculation devices may be used in associated device health processes. An example of a configuration view for configuring a calculation device is illustrated and described with respect to FIG. 4A below.

In operation 320, server 115 can provide (320) the performance metrics, operations, rule sets, and an instruction to perform the operations and rule sets on the performance metrics to the one or more identified calculation devices to produce the device health information. Each identified calculation device can perform device health processes to contextualize the performance metrics and produce device health metrics categories indicative of healthy or unhealthy behavior associated with the device. For example, the identified calculation devices can perform the provided operations on the performance metrics to produce device health metrics. Then, the calculation devices can apply the provided rule sets on the device health metrics to produce the device health metrics categories. The calculation devices can then provide the device health information to server 115 for instantiation of indications of the device health information on a user interface of user device 110 or 111.

FIGS. 4A, 4B, and 4C illustrate example representations of a user interface including device health metrics of industrial devices in accordance with some embodiments of the present technology. FIGS. 4A, 4B, and 4C each demonstrate an aspect of a user experience for configuring and viewing device health information corresponding to one or more industrial devices in an industrial automation environment on user interface 411 of user device 410. In various examples, a user can navigate between the aspects and views of user interface 411 shown in FIGS. 4A, 4B, and 4C by interacting with user interface 411 (e.g., tap, swipe, click). User device 410 may exemplify user device 111 of operating environment 100 of FIG. 1. The device health information displayed on user interface 411 of user device 410 may be provided by a server, such as server 115 of FIG. 1 or server 205 of FIG. 2A, 2B, or 2C.

Referring first to FIG. 4A, FIG. 4A includes aspect 401, which illustrates user device 410 and a dashboard 412-1 displayed on user interface 411 of user device 410. User device 410 is representative of a handheld device, such as a smart phone or tablet, having a touchscreen that can be used to both display information on user interface 411 and provide for interaction with dashboard 412-1, configuration view 414-1 of dashboard 412-1, and other views and dashboards of a device health application displayed on user interface 411.

User interface 411 may display an instance of the device health application that may run on user device 410. The instance displayed on user interface 411 may include one or more navigable dashboards (e.g., dashboard 412-1), each having information about the industrial devices and related performance and health obtained from a server. For example, dashboard 412-1 may show industrial system 413, a configuration view 414-1, and selections, text boxes, and other options for interacting with the device health application.

Industrial system 413 may indicate which industrial device or industrial system of industrial devices user interface 411 is displaying information about. In some cases, user device 410 may be connected to one or more devices of industrial system 413 or a controller coupled to devices of industrial system 413. In this example, industrial system 413 indicates that the system is named “PowerFlex 755TS Conveyor C6 Head,” which may include various devices, components, and equipment that can perform an industrial or commercial process.

Configuration view 414-1 illustrates a view instantiated on user interface 411 for creating a device health metric and selecting one or more calculation devices to perform operations on the device health metric. Configuration view 414-1 may include text boxes, drop-down menus, check-boxes, selection windows, and the like that a user can interact with to select calculation devices for which to perform device health metric operations and produce device health metrics and device health metrics categories for use in device health processes described and illustrated in aspects 501-506. For example, configuration view 414-1 includes device health metric name 415, operation 416, calculation device(s) 417, and source data 418.

Device health metric name 415 corresponds to a name for a device health metric. For example, referring ahead to aspect 403 of FIG. 4C, device health metric name 415 corresponding to device health metrics 425-1 may be “motor speed percentage.” In various examples, device health metric name 415 may include a text box that a user can type letters or other characters into via a keyboard on user interface 411 of user device 410.

Operation 416 corresponds to the name of an operation performable on a device health metric. Operation 416 may include mathematical operations, filter functions, compare functions, and other operations. For example, referring ahead to aspect 403 of FIG. 4C, operation 416 for producing device health metrics 425-1 may include a conversion operation to convert an output current of a device of industrial system 413 to a percentage value. In some cases, more than one operation can be selected, such as via checkboxes on configuration view 414-1. Operation 416 may also be selected via a drop-down menu or selection window, among other selection mechanisms.

Calculation device(s) 417 corresponds to a name of a device that can perform operation 416 to produce the device health metric. For example, calculation device(s) 417 may include one or more servers (e.g., server 115 or cloud-based server 125 of FIG. 1), one or more industrial devices of industrial system 413 (e.g., industrial devices 120 of FIG. 1), a controller coupled to an industrial device (e.g., controller 123 of FIG. 1), a user interface device coupled to an industrial device (e.g., user interface module 122 of FIG. 1), and a user device (e.g., user device 110 or user device 111 of FIG. 1). Calculation device(s) 417 may be selected via checkboxes, a drop-down menu, or the like. In some cases, calculation device(s) 417 may be pre-populated based on operation 416 or industrial system 413. For example, a specific calculation device may be dedicated to performing a certain type of operation 416.

Source data 418 corresponds to a source for raw data to be used in the contextualization and classification of the device health metric. For example, referring ahead again to aspect 403 of FIG. 4C, source data 418 corresponding to device health metrics 425-1 may be a motor of industrial system 413. More particularly, source data 418 may include a current or motor speed of the motor. Source data 418 of device health metrics 425-1 may be a DC bus of industrial system 413. Other examples of source data 418 include sensors, gears, belts, drives, or any other device of industrial system 413 that produces a signal indicative of performance of the device. A user may select source data 418 from a drop-down list based on industrial system 413.

Various other selections and modifications may be included in configuration view 414-1. The selections shown may be pre-configured or may be selected in another configuration view (not shown). Further, the items in drop-down lists, checkboxes, or the like may be pre-configured, automatically populated based on industrial system 413, a previously selected item in configuration view 414-1, or edited during run-time in another configuration view. Accordingly, any combination or variation of configuration parameters and selections may be contemplated to build a user experience for a user of user device 410 in performing device health processes. As selections are saved in configuration view 414-1 and requests for data are made by a user, device health metrics and device health metrics categories may be produced by calculation device(s) 417 and data may be surfaced on user interface 411 as illustrated in the various views of aspects 402 and 403.

FIG. 4B includes aspect 402, which illustrates device triage view 414-2 on user interface 411 of user device 410. Device triage view 414-2 may illustrate one of several views on dashboard 412-1. Device triage view 414-2 may include device health topics 420 corresponding to industrial system 413 and status indications 421 corresponding to each of device health topics 420.

Device triage view 414-2 refers to a name of a page or view on dashboard 412-1 that can be displayed on user interface 411. In aspect 402, device triage view 414-2 may include device health topics 420 and corresponding status indications 421. Device health topics 420 include various device health or condition related topics, such as device vitals, device state, predictive maintenance, preventative maintenance, unhealthy behavior, condition monitoring, and computerized maintenance management system (CMMS). Conditioning monitoring may include software that receives data from smart devices and performs motor current signature analysis and inform potential problems such as motor bearings issues and pump cavitation, for example. CMMS may include software that helps manage assets, schedule maintenance, and track work orders, for example. Status indications 421 may indicate a healthy status, an unhealthy status, or an approaching unhealthy status.

In use, user device 410 can connect to a server and one or more industrial devices in an industrial automation environment via a wireless connection (e.g., Bluetooth, Wi-Fi, NFC). In some cases, user device 410 can connect directly to an industrial device. In other cases, user device 410 may connect to a controller (e.g., a PLC) coupled to the industrial device. Regardless, user device 410 can request information related to performance and health of the industrial devices from the server and the industrial devices. The server can receive the request and provide the request to one or more calculation devices configured to perform operations to produce device health information (i.e., as configured in configuration view 414-1 of FIG. 4A). The one or more calculation devices can obtain performance metrics from the selected industrial devices and perform device health processes, such as processes described above in FIGS. 2A, 2B, 2C, and 3, and provide indications of health and performance metrics for display on user interface 411.

Referring next to FIG. 4C, FIG. 4C includes aspect 403, which illustrates device vitals view 414-3 on user interface 411 of user device 410. Device vitals view 414-3 may include contextualized performance metrics of industrial system 413, or devices of industrial system 413, related to device health topic 420-1, device vitals. In this example, device vitals view 414-3 includes device health metrics 425-1-1, device health metrics 425-2, and device health metrics 425-3.

Device health metrics 425-1 includes contextualized performance metrics derived from current outputs of industrial system 413. More specifically, device health metrics 425-1 includes a motor speed percentage, (95%), a drive usage percentage (82.5%), a peak motor speed percentage (101%), and a peak drive usage percentage (87%). These values may indicate whether industrial system 413, or more particularly the motor and drive of industrial system 413, are operating below, at, or above a capacity.

Device health metrics 425-2 includes contextualized performance metrics derived from voltage outputs of industrial system 413. More specifically, device health metrics 425-2 includes average DC bus voltage (677.28 V), unfiltered DC bus voltage (689.31 V), and DC bus bias ripple (4.2%). These values may indicate whether a DC bus of industrial system 413 is outputting too much, too little, or a normal voltage to other devices in industrial system 413.

Device health metrics 425-3 includes contextualized performance metrics derived from motor outputs of industrial system 413. More specifically, device health metrics 425-3 includes a motor overload value (86%) and a motor setting (10). These values may indicate whether the motor of industrial system 413 is overloaded or operating normally.

In various examples, a calculation device (e.g., calculation device(s) 417) can determine device health metrics 425-1, 425-2, and 425-3 by contextualizing performance metrics of industrial system 413. Performance metrics may include raw outputs or signals obtained from industrial system 413, such as output current, output voltage, and motor speed, among other signals. The calculation device can contextualize device health metrics 425-1, 425-2, and 425-3 by using contextualization information specific to a metric of device health metrics 425-1, 425-2, and 425-3 and performing one or more operations on the metrics. Contextualization information may refer to information indicative of a type of a value (e.g., voltage, temperature, current, speed) or unit of measurement of a value (e.g., volts, degrees Fahrenheit, amps, RPM). By way of example, to determine the motor speed percentage of device health metrics 425-1, the calculation device may perform one or more operations using the output current of a motor of industrial system 413, such as an operation to convert the output value current from amps to a percentage based on the total capable motor speed. By way of another example, to determine the peak motor speed percentage of device health metrics 425-1, the calculation device may perform one or more different operations using the output current of the motor of industrial system 413. Thus, the calculation device can perform any combination or variation of operations based on desired output metrics in device health metrics 425-1, 425-2, and 425-3 for display in device vitals view 414-3, which may be configured in configuration view 414-1 of FIG. 4A.

The calculation device may account for device health metrics 425-1, 425-2, and 425-3, among other metrics, to determine status indication 516-1. For example, the calculation device can apply one or more rule sets to device health metrics 425-1, 425-2, and 425-3 to determine whether any values within device health metrics 425-1, 425-2, and 425-3 exceed unhealthy threshold values. In cases where device health metrics 425-1, 425-2, and 425-3 include values that do not exceed threshold values, status indication 516-1 can indicate that device health topic 515-1 includes healthy metrics.

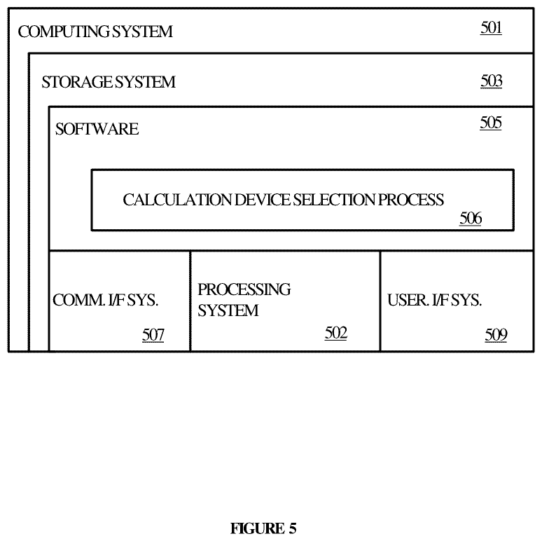

FIG. 5 illustrates computing system 501 to perform device health metric contextualization and classification via selected calculation devices, according to an implementation of the present technology. Computing system 501 is representative of any system or collection of systems with which the various operational architectures, processes, scenarios, and sequences disclosed herein for calculation device identification and configuration may be employed. Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 509 (optional). Processing system 502 is operatively coupled with storage system 503, communication interface system 507, and user interface system 509. Computing system 501 may be representative of a cloud computing device, distributed computing device, or the like.

Processing system 502 loads and executes software 505 from storage system 503. Software 505 includes and implements calculation device selection process 506, which is representative of any of the performance metrics gathering, contextualization, categorization, and classification processes and calculation device identification, selection, and configuration processes discussed with respect to the preceding Figures. When executed by processing system 502 to provide device health metrics functions, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 include general purpose central processing units, graphical processing units, application specific processors, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including calculation device selection process 506) may be implemented in program instructions and among other functions may, when executed by processing system 502, direct processing system 502 to operate as described with respect to the various operational scenarios, sequences, and processes illustrated herein. For example, software 505 may include program instructions for implementing a device health metrics process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to provide device health metrics and contextualization and instantiation thereof as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected.” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A method, comprising:
obtaining a request from a user device for device health information corresponding to a device in an industrial automation environment;
identifying, based on the request, performance metrics associated with the device and one or more operations for producing the device health information from the performance metrics;
identifying one or more calculation devices to perform at least a subset of the one or more operations; and
providing the performance metrics, the subset of the one or more operations, and an instruction to perform the subset of the one or more operations on the performance metrics to the one or more calculation devices to produce the device health information.

2. The method of claim 1, further comprising obtaining the device health information from the one or more calculation devices.

3. The method of claim 2, further comprising providing indications of the device health information to a user interface of the user device for display of the device health information.

4. The method of claim 3, wherein identifying the one or more calculation devices is based on a latency between obtaining the device health information from the one or more calculation devices and providing the indications of the device health information to the user interface.

5. The method of claim 1, wherein identifying the one or more calculation devices is based on an available processing capacity of the one or more calculation devices.

6. The method of claim 1, wherein the one or more calculation devices comprises an edge server, a cloud server, the device, a controller associated with the device, or a combination thereof.

7. The method of claim 1, wherein identifying the one or more calculation devices comprises identifying a first calculation device to perform a first subset of the one or more operations and identifying a second calculation device to perform a second subset of the one or more operations different from the first subset.

8. The method of claim 1, wherein performing the subset of the one or more operations on the performance metrics comprises contextualizing each of the performance metrics based on contextualization information specific to each of the performance metrics.

9. The method of claim 8, wherein the contextualization information comprises signals indicative of one or more of an electrical value, a mechnical value, and a thermal value associated with the device.

10. The method of claim 8, wherein performing the one or more operations on the performance metrics further comprises applying a rule set to each of the contextualized performance metrics, wherein the rule set is selectively applied to a respective contextualized performance metric based on a type of the contextualized performance metric.

11. The method of claim 1, further comprising receiving a user input defining the one or more calculation devices.

12. The method of claim 1, further comprising:
identifying a new device in the industrial automation environment;
identifying further performance metrics associated with the new device;
identifying a calculation device of the one or more calculation devices to perform at least a subset of the one or more operations on the further performance metrics; and
performing, based on a new request from the user device, the subset of the one or more operations on the further performance metrics to produce further device health information associated with the new device.

13. The method of claim 12, wherein identifying the calculation device to perform at least the subset of the one or more operations on the further performance metrics comprises applying a machine learning model to the new device.

14. The method of claim 1, wherein the device is a variable-speed drive.

15. The method of claim 1, wherein the device health information is indicative of a health of the device.

16. One or more computer-readable storage media having program instructions stored thereon, wherein the program instructions, when read and executed by one or more processors, direct the one or more processors to:
obtain a request from a user device for device health information corresponding to a device in an industrial automation environment;
identify, based on the request, performance metrics associated with the device and one or more operations for producing the device health information from the performance metrics;
identify one or more calculation devices to perform at least a subset of the one or more operations; and
provide the performance metrics, the one or more operations, and an instruction to perform the one or more operations on the performance metrics to the one or more calculation devices to produce the device health information.

17. The one or more computer-readable storage media of claim 16, wherein the program instructions further direct the one or more processors to obtain the device health information from the one or more calculation devices.

18. The one or more computer-readable storage media of claim 17, wherein the program instructions further direct the one or more processors to provide indications of the device health information to a user interface of the user device for display of the device health information.

19. The one or more computer-readable storage media of claim 18, wherein to identify the one or more calculation devices, the program instructions direct the one or more processors to identify the one or more calculation devices based on a latency between obtaining the device health information from the one or more calculation devices and providing the indications of the device health information to the user interface.

20. The one or more computer-readable storage media of claim 16, wherein the one or more calculation devices comprise an edge server, a cloud server, the device, a controller associated with the device, or a combination thereof.
